(19) United States
(12) Patent Application Publication
(10) Pub. No.: US 2022/0281094 A1
(43) Pub. Date: Sep. 8, 2022

(54) Modular Power Tool Apparatus

(71) Applicant: Photonix Products LLC, Chicago, IL (US)

(72) Inventor: Edwin Williams, Chicago, IL (US)

(21) Appl. No.: 17/526,457

(22) Filed: Nov. 15, 2021

Related U.S. Application Data
(63) Continuation-in-part of application No. 29/804,014, filed on Aug. 17, 2021.
(60) Provisional application No. 63/158,007, filed on Mar. 8, 2021.

(51) Int. Cl. B25F 3/00; B25F 5/02; F21S 9/02; F21V 23/04; F21V 33/00

(52) U.S. Cl. CPC B25F 3/00; B25F 5/02; F21S 9/02; F21V 23/04; F21V 33/0084; B23D 51/10

(57) ABSTRACT

A modular power tool apparatus provides a plurality of tool heads that are interchangeable between a selected tool head and any other comparable tool head, providing a user or operator the means to rapidly reconfigure a power tool for multiple roles and functions. The power unit is provided with an output shaft, a receiving cavity, and at least one locking mechanism. The output shaft is configured to engage to an input socket of the selected tool head a surrounding shell wall is positioned into the receiving cavity. The at least one locking mechanism captures at least one shelf on the shell wall to releasably fix the selected tool head into an operable configuration with the power unit.

The current application claims a priority to the U.S. Provisional Patent application Ser. No. 63/158,007 filed on Mar. 8, 2021.

### FIELD OF THE INVENTION

The present invention generally relates to a portable saw tool with detachable heads. More specifically, the present invention relates to a modular assembly designed to easily swap between all types of power tool attachments via a compatibilized engagement structure.

### BACKGROUND OF THE INVENTION

Power tools are essential for development, construction and/or any other related work. However, most power tools are limited by application to a single function or utility. Accordingly, the type of work or job a user is taking on usually dictates the type of power tools a user will need. This naturally means that to successfully approach any type of work which requires power tools, one must own, maintain, and carry a variety of power tools to any given job site. For example, if a user is performing a job that requires a cutting power tool, then the user must provide the correct variety of cutting tool, along with the corresponding blade or cutting implement. In another instance, if a user needs a cutting tool comprising a circular blade but only has access to a reciprocating blade, then the user is forced to acquire a different blade. Thus, there is a need for a cutting power tool which proves user with ample versatility, ease of use, and efficiency. The present invention aims to provide the user with a cutting power tool which comprises saw attachments with different types of saw blades.

The following document aims to provide an accurate and detailed description of the present invention without limiting the scope of the invention, and the accompanying figures are only intended to help illustrate the present invention. Thus, the accompanying figures do not limit the scope of the invention in any way, shape or form.

### BRIEF DESCRIPTION OF THE DRAWINGS

FIG. 1 is a top-front-right perspective view of one embodiment of the present invention, wherein a variety of interchangeable components are illustrated in exemplary form.

FIG. 2 is a top-front-left exploded view thereof.

FIG. 3 top-front-right exploded view of one embodiment of the present invention, wherein the interchangeable tool element is disassembled to illustrate construction.

FIG. 4 is a top-front-left exploded view of one embodiment of the present invention, wherein the modular base component is disassembled to illustrate construction.

FIG. 5 is a front elevational view of one embodiment of the present invention.

FIG. 6 is a section view taken along line 6-6 in FIG. 5.

FIG. 7 is a detail view of area 7 in FIG. 5.

FIG. 8 is a detail view of area 8 in FIG. 5.

FIG. 9 is a detailed exploded view of one embodiment of the present invention, wherein the explosion vectors are shown in broken-line.

FIG. 10 is a section view taken along line 10-10 in FIG. 5.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

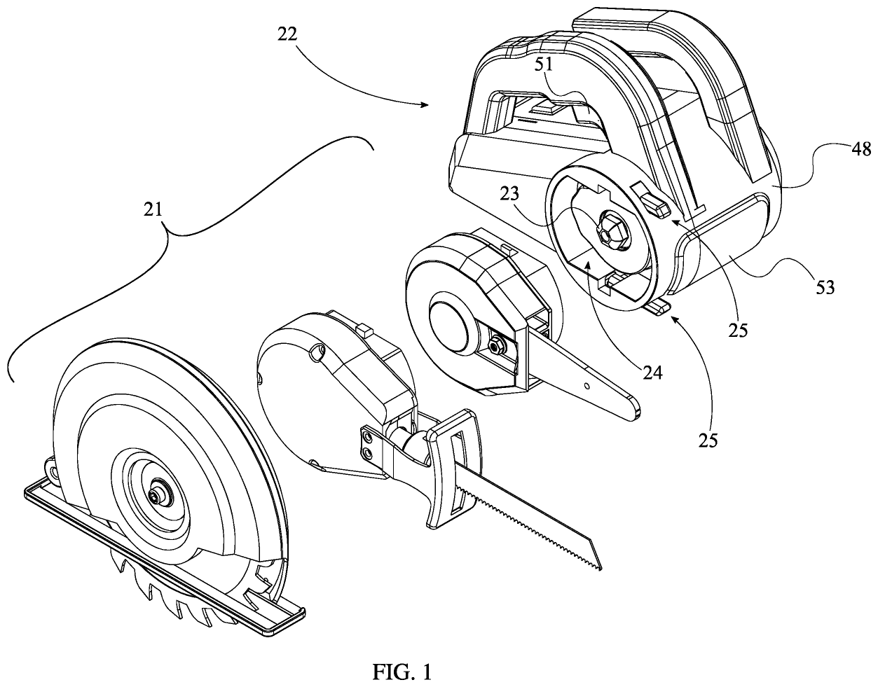

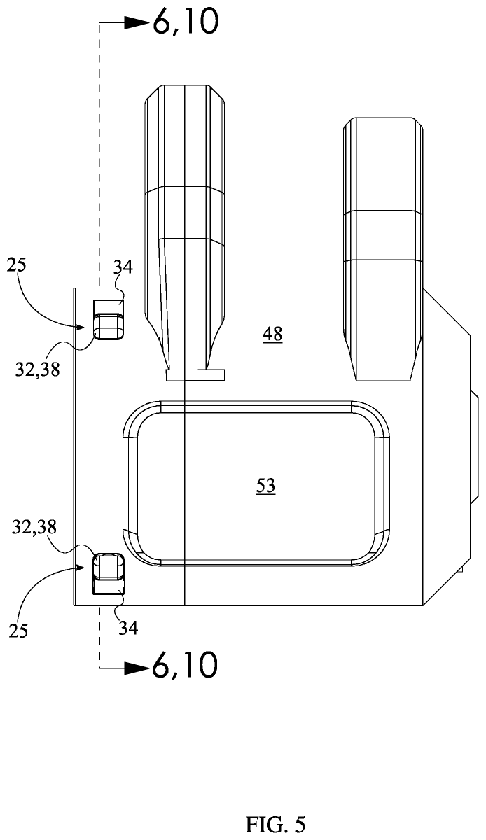

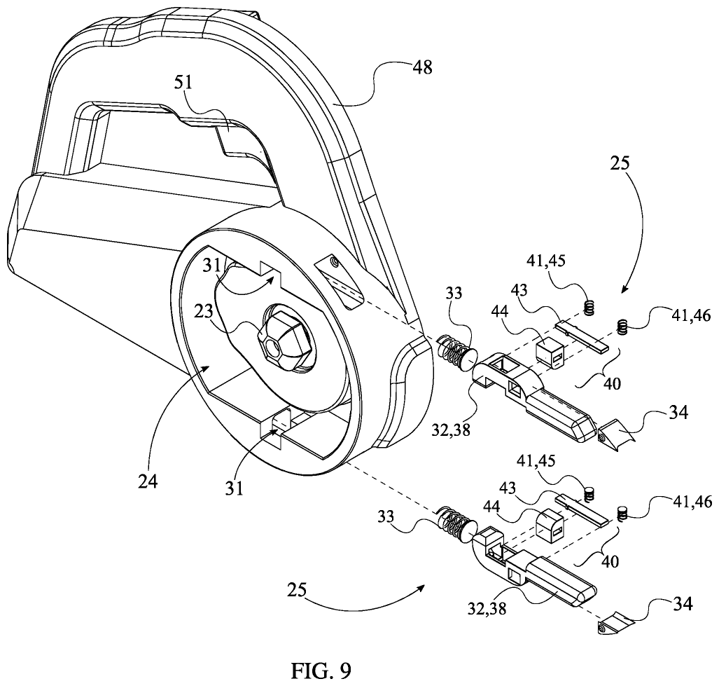

In reference to FIG. 1 through 10, the present invention is a modular power tool apparatus provided to enable a single operator to rapidly, effectively convert a standardized power tool to utilize a variety of interchangeable components to expand the functionality of the present invention beyond any single type of tool. In practice, unitization of the interchangeable tooling components enables a single operator to reduce the number of discrete tools carried by an individual worker.

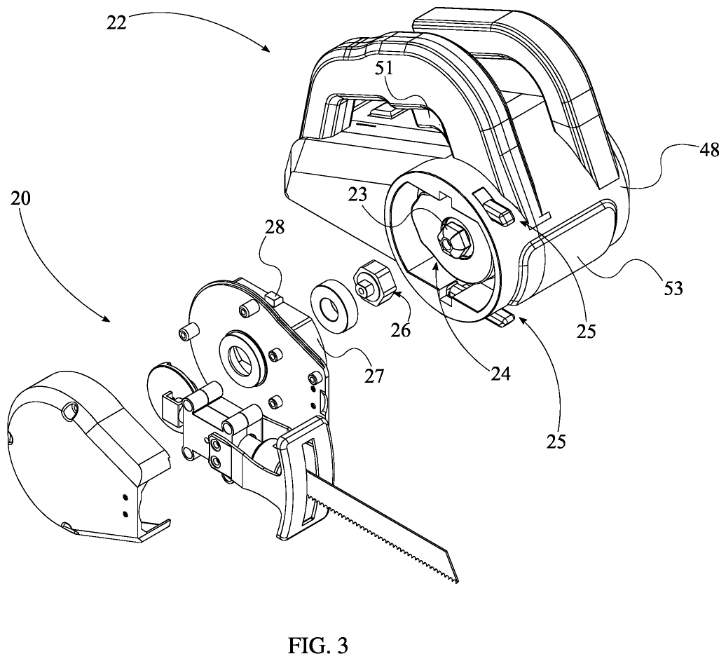

In reference to FIGS. 1 and 3, the modular power tool apparatus comprises a selected tool head 20 from a plurality of tool heads 21 mounted to a power unit 22. The plurality of tool heads 21 broadly encompasses any type, variety, specification, or description of power tools sharing a common attachment and power transmission assembly compatible with the power unit 22. Accordingly, the power unit 22 constitutes a universal means of supplying nay necessary rotational, electrical, or compressive force required to operate the plurality of tool heads 21. The selected tool head 20 is referred to by description and illustration as an exemplary configuration of the present invention, but this singular embodiment should not be construed as a limitation to the overall scope and scale of the invention.

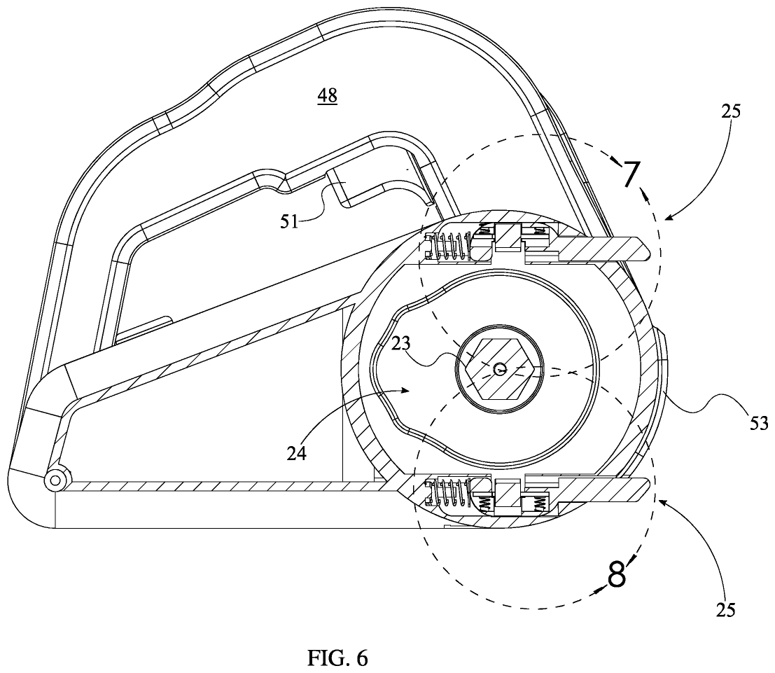

Referring to FIGS. 1 and 3, the power unit 22 comprises an output shaft 23, a receiving cavity 24, and at least one locking mechanism 25. The output shaft 23 constitutes a universal engaging peg, bolt, arbor, or chuck suitable for transferring power to the selected tool head 20. The receiving cavity 24 broadly refers to an indentation formed about the output shaft 23 to permit the solid attachment of the selected tool head 20 therein, both physically limiting the separation between the power unit 22 and the tool head and rotationally fixing the selected tool head 20 into alignment with the power unit 22. Accordingly, the output shaft 23 is positioned within the receiving cavity 24 as shown in FIG. 3. The at least one locking mechanism 25 refers to a releasable, manually operated arrangement of interference components arranged to prevent the unintentional removal of the selected tool head 20 from the power unit 22. In the exemplary embodiment shown in FIG. 6, the at least one locking mechanism 25 is illustrated as a redundant feature on opposing sides of the receiving cavity 24. The at least one locking mechanism 25 is perimetrically engaged into the receiving cavity 24 to enable the selected tool head 20 to be mounted at dispersed positions distal to the output shaft 23, thereby improving the mechanical advantage of the at least one locking mechanism 25 against the output shaft 23. This arrangement, and other comparable arrangements, are broadly included among many potential embodiments of the present invention. No limitations should be implied based upon illustrated angular incidence of the at least one locking mechanism 25 to the receiving cavity 24, nor should the illustration of a two-position embodiment be read as a limitation to the potential variants of the present invention.

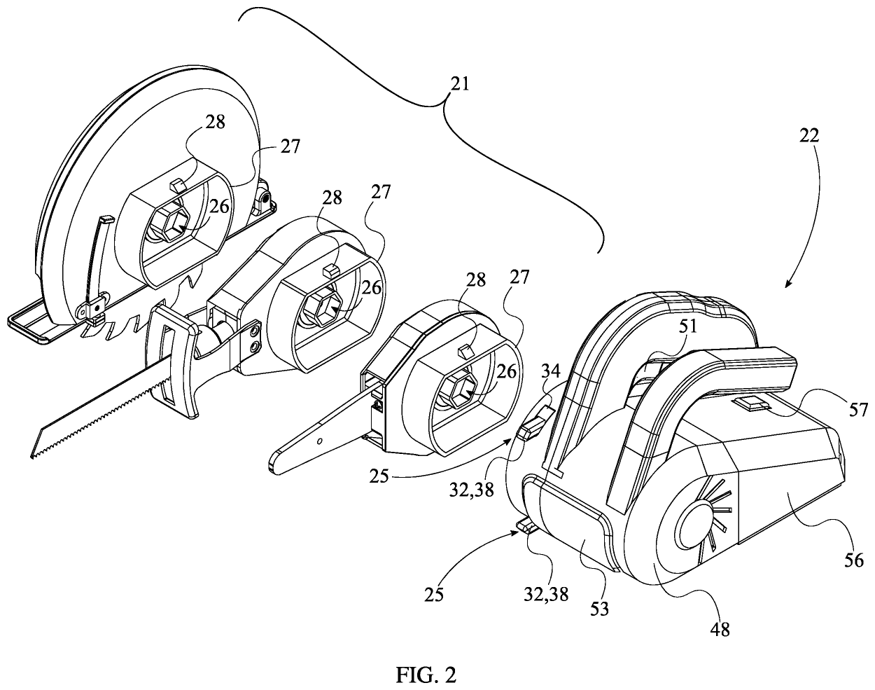

As illustrated in FIG. 2, each of a plurality of tool heads 21 comprises an input socket 26, a shell wall 27, and at least one shelf 28. The input socket 26 defines a mutually compatible, opposed structure to the output shaft 23 of the power unit 22. The input socket 26 is preferably arranged such that the normal engagement of the shell wall 27 into the receiving cavity 24 aligns and indexes the input socket 26 to the output shaft 23. Accordingly, the input socket 26 is positioned within the shell wall 27 to provide a durable insertion guide and alignment structure for the input socket 26 to reliably engage onto the output shaft 23. Further, the at least one shelf 28 extends from the shell wall 27, opposite the input socket 26 as indicated in FIG. 3. The at least one shelf 28 serves as a retention feature when combined with he at least one locking mechanism 25, wherein the at least one locking mechanism 25 operably captures and holds the at least one shelf 28 until manually released by an operator.

In an operable configuration, the shell wall 27 is inserted into the receiving cavity 24 to physically engage the selected tool head 20 to the power unit 22. It is further proposed that the geometric profiles of the receiving cavity 24 and the shell wall 27 are irregular and configured to prevent rotation of the selected tool head 20 relative to the power unit 22 without an intentional reconfiguration by an operator. This ideally prevents slippage of the selected tool head 20 during use in regular conditions, but also adsorbs a portion of any tortional stresses that may otherwise be exerted across the at least one locking mechanism 25. Further, the input socket 26 is rotationally engaged to the output shaft 23, wherein the power unit 22 supplies operating power to the selected tool head 20. This engagement is ideally guided by the alignment of the shell wall 27 and the receiving cavity 24 to ensure a proper connection, but it is further proposed that the surface features of the output shaft 23 and the input socket 26 may include angled surfaces, slopes, or chamfers to assist final alignment. Further, the profiles of the input socket 26 and the output shaft 23 are ideally complimentary as shown in FIGS. 1 and 2 to prevent slippage, similar to the profiles of the shell wall 27 and the receiving cavity 24. Finally, the at least one shelf 28 is releasably engaged into the at least one locking mechanism 25 as a final retentive measure. In this configuration, the shell wall 27 is positioned into the receiving cavity 24 and remains fixed in position until the operator releases the at least one shelf 28 from the at least one locking mechanism 25. Once disengaged, the selected tool head 20 may be removed from the power unit 22 and replaced with one of the plurality of tool heads 21 as outlined above.

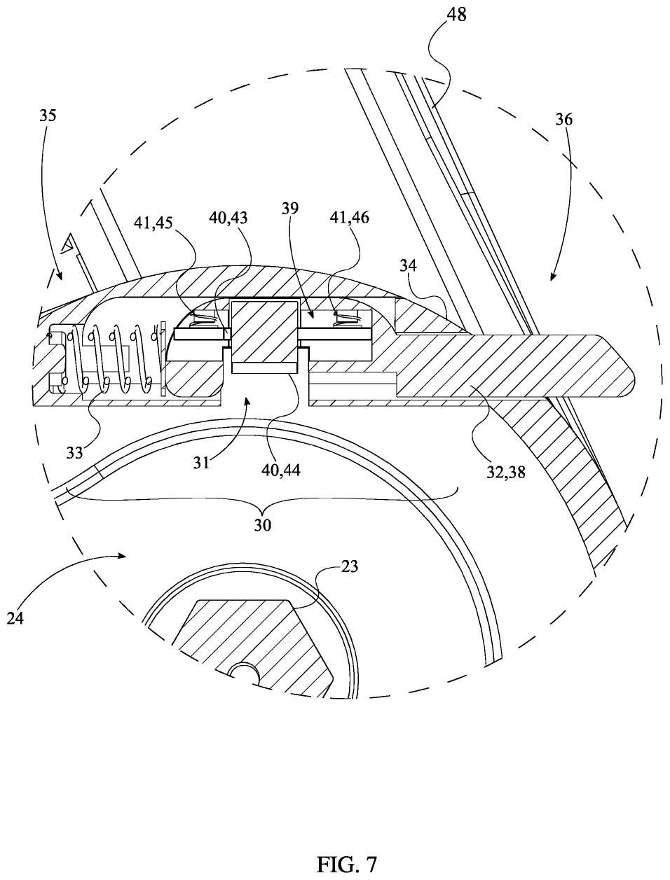

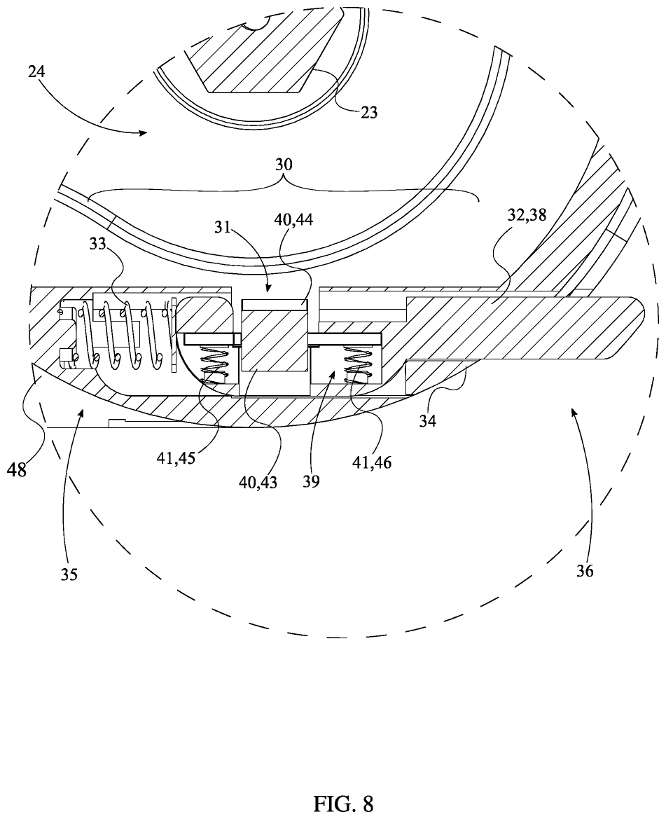

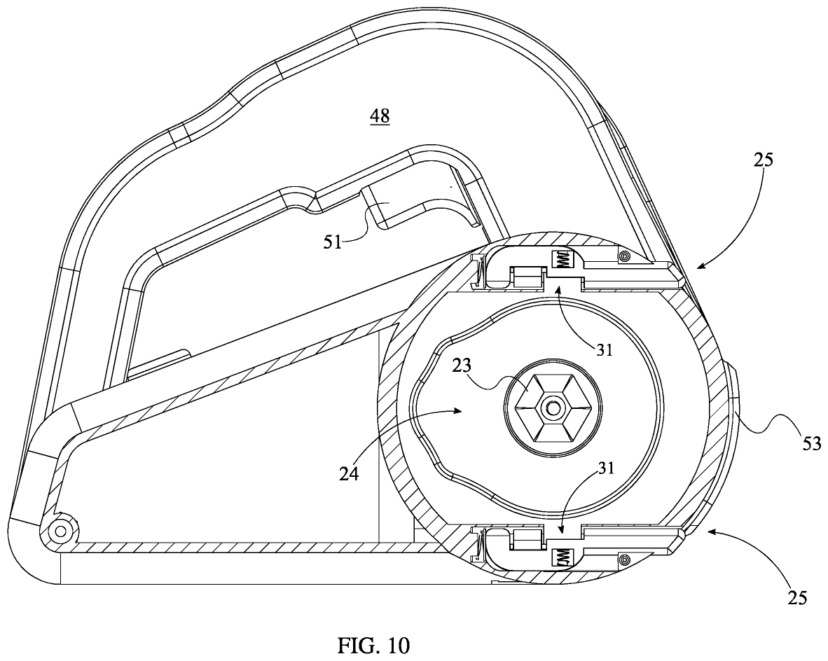

In another embodiment of the present invention, each of the at least one locking mechanism 25 further comprises a channel 30, a keyway 31, a lock member 32, a mainspring 33, and a blocking plate 34 as illustrated in FIGS. 7 and 8. The channel 30 and the lock member 32 extend between a rear end 35 and a fore end 36, adjacent to the receiving cavity 24 as shown in FIGS. 6 and 10, wherein the overall length of the lock member 32 is ideally greater than the channel 30 such that the lock member 32 protrudes from the fore end 36 of the channel 30. This exposed segment of the lock member 32 enables an operator to manually actuate the lock member 32, directly operating the locking mechanism 25. The channel 30 defines a clearance area or voided space positioned to enable the lock member 32 therein to operably obstruct t the keyway 31. Accordingly, the keyway 31 is formed between the channel 30 and the receiving cavity 24, perpendicular to the channel 30 to provide a path for the at least one shelf 28 to traverse the channel 30 as the shell wall 27 is inserted into the receiving cavity 24. The lock member 32 is slidably engaged into the channel 30, wherein the lock member 32 operably obstructs the keyway 31. As shown in exemplary in FIG. 10, the operator forces the lock member 32 towards the rear end 35 of the channel 30 to clear the keyway 31, allowing passage of the at least one shelf 28 and disposition of the selected tool head 20 at large. Conversely, the lock member 32 obstructs the keyway 31 absent any external action from the operator, preventing the at least one shelf 28 from traversing the keyway 31. This arrangement necessitates that the lock member 32 normally returns to the fore end 36 of the channel 30 at rest, necessitating that the mainspring 33 is engaged against the lock member 32. More specifically, the mainspring 33 is positioned between the rear end 35 and the lock member 32 as shown in FIGS. 7 and 8. It is further understood that the lock member 32 must be limited in travel towards the fore end 36 to prevent the mainspring 33 from ejecting the lock member 32 from the channel 30 entirely. Therefore, the blocking plate 34 is mounted adjacent to the fore end 36, over the locking member, wherein the blocking plate 34 retains the locking member within the channel 30 under pressure from the mainspring 33. As shown in the exemplary embodiment in FIGS. 1 and 2, the blocking plate 34 ideally provides a partial obstruction to the channel 30 to enable the locking member to protrude outward from the channel 30, enabling the manual actuation of the lock member 32 as previously outlined.

In another embodiment of the present invention, the at least one locking mechanism 25 is configured to enable the power unit 22 to engage with the selected tool head 20 without manually operating the at least one locking mechanism 25. This quick-attach functionality minimizes the requisite operations to mount or interchange any of the plurality of tool heads 21, while retaining the necessary retention functions of the locking mechanism 25. I.e., the operator may simply press the shell wall 27 into the receiving cavity 24 and the at least one shelf 28 will automatically clear and re-engage the at least one locking mechanism 25 until manually released by the operator. In reference to FIGS. 7 and 8, the lock member 32 further comprises a lock body 38, a secondary cavity 39, a falling block 40, and at least one minor spring 41. The lock body 38 refers to the substantially rigid outer structure of the lock member 32 configured to receive and retain all features of the auto-locking functionality provided by this embodiment of the present invention. The secondary cavity 39 is formed into the lock body 38 between the fore end 36 and the rear end 35 to provide clearance for falling block 40 and the at least one minor spring 41 therein. Accordingly, the falling block 40 is slidably positioned into the keyway 31, wherein the secondary cavity 39 is configured to receive the falling block 40 under force from the at least one shelf 28. In practice, the engagement of the selected tool head 20 to the power unit 22 introduces the at least one shelf 28 into the keyway 31 via the alignment of the shell wall 27 into the receiving cavity 24. The at least one shelf 28 is ideally chamfered or angled into the keyway 31 such that the falling block 40 is forced into the secondary cavity 39 until the shell wall 27 is fully seated into the receiving cavity 24, corresponding to the at least one shelf 28 fully traversing the keyway 31. Further, the at least one minor spring 41 is positioned in the secondary cavity 39 between the lock body 38 and the falling block 40, wherein the at least one minor spring 41 biases the falling block 40 into the keyway 31. The force of the at least one minor spring 41 reinserts the falling block 40 into the keyway 31 behind the at least one shelf 28, thereby preventing the extraction of the selected tool head 20 from the power unit 22. In this arrangement the falling block 40 functions as a one-way gate into the keyway 31 when the lock member 32 is at rest, wherein the keyway 31 remains obstructed until the lock member 32 is displaced to the rear end 35 as shown in FIG. 10. This operation traverses the lock body 38, and the falling block 40 by extension, towards the rear end 35 of the channel 30 to unblock the keyway 31 and enable the removal of the at least one shelf 28 and the selected tool had by extension.

It is further proposed that the one-way gate of the falling block 40 may be improved by introducing a means of incorporating multiple, balanced force elements between the lock body 38 and the falling block 40. It if further proposed that the introduction of a separable locking assembly may simplify the manufacture of such a fine mechanism, referring both to the separating of moving parts and the ease of assembly into the lock body 38. In further reference to FIG. 6 through 9, in a preferred embodiment of the present invention the falling block 40 further comprises a retention bar 43 and a central tooth 44. The at least one minor spring 41 also further comprises a first spring 45 and a second spring 46. The retention bar 43 is mounted into the secondary cavity 39, perpendicular to the keyway 31, with the central tooth 44 mounted onto the retention bar 43. In the arrangement shown in FIG. 8, the central tooth 44 ordinarily protrudes into the keyway 31 while the retention bar 43 protrudes into secondary cavity 39, thereby preventing the central tooth 44 from overextending into the keyway 31 or separating from the lock body 38. The first spring 45 and the second spring 46 are mounted between the retention bar 43 and the lock body 38, across the central tooth 44 in a bilaterally similar configuration. As shown in FIG. 7, the balanced compression of the first spring 45 and the second spring 46 provides a stable resistance to the impingement of the at least one shelf 28 onto the central tooth 44. Likewise, the position both the first spring 45 and the second spring 46 onto the common retention bar 43 ensures that the central tooth 44 remains in position to block the passage of the at least one shelf 28 backwards out of the keyway 31, even if either the first spring 45 or the second spring 46 becomes bound or broken. This redundancy improves the overall operational safety of the present invention, whereby the selected tool head 20 remains attached to the power unit 22 even in the event of partial failure of the at least one locking mechanism 25.

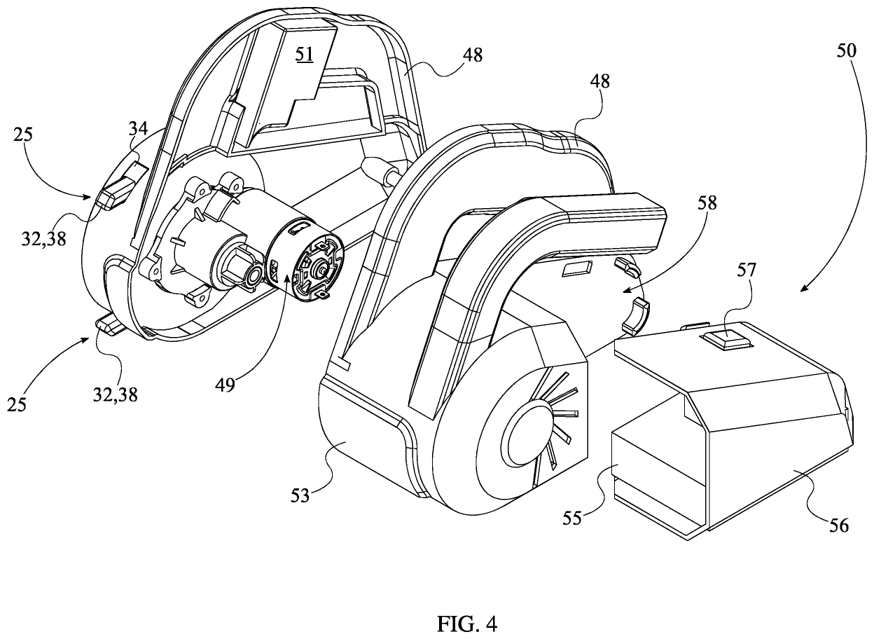

It is further considered that the power unit 22 may be compatibilized to accept the broadest possible variety among the plurality of tool heads 21, inclusive of the embodiments shown in FIGS. 1 and 2. The power unit 22 further comprises a protective casing 48, a motor assembly 49, a power supply 50, and at least one operating switch 51 as illustrated in FIG. 4. The protective casing 48 broadly refers to the outer skin or superstructure of the power unit 22, generally being analogous to the ergonomic casing of other generic power tools as may be recognized in the art. The motor assembly 49 refers to a combination of an electric motor and transmission configured for variable speed output and torque, particularly an instance of the transmission that is suitable to supply operating power to a wide range of tools. The power supply 50 likewise refers to an electric power source suitable for driving the motor assembly 49 in conjunction with the variety of tools. The motor assembly 49 and the power supply 50 are both mounted into the protective casing 48, with the motor assembly 49 positioned opposite to the receiving cavity 24 across the protective casing 48. The output shaft 23 traverses the protective casing 48 and is connected to the motor assembly 49, ensuring that the operating portions of the motor assembly 49 are shielded from any external damage or debris within the protective casing 48. The power supply 50 is electrically connected to the motor assembly 49 across the at least one operating switch 51, enabling the operator to moderate the flow of electrical energy between the power supply 50 and the motor assembly 49.

It is further proposed that the power unit 22 provides an integrated work light or source of illumination to enable an operator to use the present invention in low-light areas. As indicated in FIG. 1, the power unit 22 further comprises at least one illuminator 53 positioned orthogonal to the receiving cavity 24. The at least one illuminator 53 ideally refers to a light-emitting diode (LED) panel or array suitable for illuminating a work surface ahead of the selected tool head 20. The power supply 50 is electrically connected to the at least one illuminator 53 across the at least one operating switch 51, enabling the function of the at least one illuminator 53 to be tied into the operation of the motor assembly 49. In one instance, the operating of the at least one operating switch 51 may illuminate the working area prior to providing power to the motor assembly 49, thereby ensuring that an operator can confirm their cutting angle prior to engaging the selected tool head 20.

It is further proposed that the present invention may provide a means of interchanging the power supply 50, either to continue using the present invention after expending the power supply 50 or to provide an alternative embodiment of the power supply 50 that is required or suitable for use with the selected tool head 20. For example, one instance of the power supply 50 may provide a 12 v supply, whereas another instance of the elected tool head may require an 18 v power supply 50. Accordingly, the power supply 50 must be exchanged in conjunction with the plurality of tool heads 21 to maintain functionality. Referring to FIG. 4, the power supply 50 further comprises a battery array 55, a battery casing 56, and at least one power interconnection 57. The battery array 55 preferably refers to a series of cellular batteries arranged to provide an appropriate operating voltage and current for the selected tool head 20. In various alternate embodiments, the type and variety of power storage component utilized in the battery array 55 may be altered without departing from the original spirit and scope of the present invention. The protective casing 48 further comprises a battery bay 58, constituting a designated and compartmentalized region of the protective casing 48 of appropriate dimensions and scale to receive the battery casing 56. As shown in FIGS. 1 and 2, the battery casing 56 preferably fits flush to the protective casing 48 to minimize any exposure of the battery array 55 therein, minimizing the risk of the battery array 55 being damaged during use. The battery casing 56 is releasably fixed into the battery bay 58 with the at least one power interconnection 57 being electrically connected between the motor assembly 49 and the battery array 55. The at least one power interconnection 57 constitutes any means of establishing a conductive path between the battery array 55 and the at least one operating switch 51. In at least one embodiment, the mechanical means of attaching the battery casing 56 to the protective casing 48 is integrated to the at least one power interconnection 57, wherein the operator may physically and electrically connect the disparate assemblies across this singular component.

Although the invention has been explained in relation to its preferred embodiment, it is to be understood that many other possible modifications and variations can be made without departing from the spirit and scope of the invention as hereinafter claimed.

What is claimed is:

1. A modular power tool apparatus comprising:
a selected tool head from a plurality of tool heads being mounted to a power unit;
the power unit comprising an output shaft, a receiving cavity, and at least one locking mechanism;
the output shaft being positioned within the receiving cavity;
the at least one locking mechanism being perimetrically engaged into the receiving cavity;
each of the plurality of tool heads comprising an input socket, a shell wall, and at least one shelf;
the input socket being positioned within the shell wall;
the at least one shelf extending from the shell wall, opposite the input socket;
the shell wall being inserted into the receiving cavity;
the input socket being rotationally engaged to the output shaft, wherein the power unit supplies operating power to the selected tool head; and
the at least one shelf being releasably engaged into the at least one locking mechanism, wherein the shell wall is positioned into the receiving cavity.

2. The modular power tool apparatus as claimed in claim 1 comprising:
each of the at least one locking mechanism further comprising a channel, a keyway, a lock member, a mainspring, and a blocking plate;
the channel and the lock member extending between a rear end and a fore end, adjacent to the receiving cavity;
the keyway being formed between the channel and the receiving cavity, perpendicular to the channel;
the lock member being slidably engaged into the channel, wherein the lock member operably obstructs the keyway;
the mainspring being positioned between the rear end and the lock member; and
the blocking plate being mounted adjacent to the fore end, over the locking member, wherein the blocking plate retains the locking member within the channel under pressure from the mainspring.

3. The modular power tool apparatus as claimed in claim 2 comprising:
the lock member further comprising a lock body, a secondary cavity, a falling block, and at least one minor spring;
the secondary cavity being formed into the lock body between the fore end and the rear end;
the falling block being slidably positioned into the keyway, wherein the secondary cavity is configured to receive the falling block under force from the at least one shelf; and
the at least one minor spring being positioned in the secondary cavity between the lock body and the falling block, wherein the at least one minor spring biases the falling block into the keyway.

4. The modular power tool apparatus as claimed in claim 2 comprising:
the falling block further comprising a retention bar and a central tooth;
the at least one minor spring being a first spring and a second spring;
the retention bar being mounted into the secondary cavity, perpendicular to the keyway;
the central tooth being mounted onto the retention bar, wherein the central tooth protrudes into the keyway; and
the first spring and the second spring being mounted between the retention bar and the lock body, across the central tooth.

5. The modular power tool apparatus as claimed in claim 1 comprising:
the power unit further comprising a protective casing, a motor assembly, a power supply, and at least one operating switch;
the motor assembly and the power supply being mounted into the protective casing;
the motor assembly being positioned opposite to the receiving cavity, across the protective casing;
output shaft traversing the protective casing and being connected to the motor assembly; and
the power supply being electrically connected to the motor assembly across the at least one operating switch.

6. The modular power tool apparatus as claimed in claim 5 comprising:
the power unit further comprising at least one illuminator positioned orthogonal to the receiving cavity; and
the power supply being electrically connected to the at least one illuminator across the at least one operating switch.

7. The modular power tool apparatus as claimed in claim 5 comprising:
the power supply further comprising a battery array, a battery casing, and at least one power interconnection;
the protective casing further comprising a battery bay;
the battery array being mounted into the battery casing;
the battery casing being releasably fixed into the battery bay; and
the at least one power interconnection being electrically connected between the motor assembly and the battery array.

8. A modular power tool apparatus comprising:
a selected tool head from a plurality of tool heads being mounted to a power unit;
the power unit comprising an output shaft, a receiving cavity, and at least one locking mechanism;
the output shaft being positioned within the receiving cavity;
the at least one locking mechanism being perimetrically engaged into the receiving cavity;
each of the plurality of tool heads comprising an input socket, a shell wall, and at least one shelf;
the input socket being positioned within the shell wall;
the at least one shelf extending from the shell wall, opposite the input socket;
the shell wall being inserted into the receiving cavity;
the input socket being rotationally engaged to the output shaft, wherein the power unit supplies operating power to the selected tool head;
the at least one shelf being releasably engaged into the at least one locking mechanism, wherein the shell wall is positioned into the receiving cavity;
each of the at least one locking mechanism further comprising a channel, a keyway, a lock member, a mainspring, and a blocking plate;
the channel and the lock member extending between a rear end and a fore end, adjacent to the receiving cavity;
the keyway being formed between the channel and the receiving cavity, perpendicular to the channel;
the lock member being slidably engaged into the channel, wherein the lock member operably obstructs the keyway;
the mainspring being positioned between the rear end and the lock member; and
the blocking plate being mounted adjacent to the fore end, over the locking member, wherein the blocking plate retains the locking member within the channel under pressure from the mainspring.

9. The modular power tool apparatus as claimed in claim 8 comprising:
the lock member further comprising a lock body, a secondary cavity, a falling block, and at least one minor spring;
the secondary cavity being formed into the lock body between the fore end and the rear end;
the falling block being slidably positioned into the keyway, wherein the secondary cavity is configured to receive the falling block under force from the at least one shelf; and
the at least one minor spring being positioned in the secondary cavity between the lock body and the falling block, wherein the at least one minor spring biases the falling block into the keyway.

10. The modular power tool apparatus as claimed in claim 8 comprising:
the falling block further comprising a retention bar and a central tooth;
the at least one minor spring being a first spring and a second spring;
the retention bar being mounted into the secondary cavity, perpendicular to the keyway;
the central tooth being mounted onto the retention bar, wherein the central tooth protrudes into the keyway; and
the first spring and the second spring being mounted between the retention bar and the lock body, across the central tooth.

11. The modular power tool apparatus as claimed in claim 8 comprising:
the power unit further comprising a protective casing, a motor assembly, a power supply, and at least one operating switch;
the motor assembly and the power supply being mounted into the protective casing;
the motor assembly being positioned opposite to the receiving cavity, across the protective casing;
output shaft traversing the protective casing and being connected to the motor assembly; and
the power supply being electrically connected to the motor assembly across the at least one operating switch.

12. The modular power tool apparatus as claimed in claim 11 comprising:
the power unit further comprising at least one illuminator positioned orthogonal to the receiving cavity; and
the power supply being electrically connected to the at least one illuminator across the at least one operating switch.

13. The modular power tool apparatus as claimed in claim 11 comprising:
the power supply further comprising a battery array, a battery casing, and at least one power interconnection;
the protective casing further comprising a battery bay;
the battery array being mounted into the battery casing;
the battery casing being releasably fixed into the battery bay; and
the at least one power interconnection being electrically connected between the motor assembly and the battery array.
